(19) United States
(12) Patent Application Publication
(10) Pub. No.: US 2007/0234687 A1
(43) Pub. Date: Oct. 11, 2007

(54) Second-stage separator device for a vacuum cleaner

(75) Inventor: Zugen Ni, Jiangsu (CN)

Correspondence Address: BUTZEL LONG, 350 SOUTH MAIN STREET, SUITE 300, ANN ARBOR, MI, 48104, US

(73) Assignee: Suzhou Kingclean Floorcare Co., Ltd.

(21) Appl. No.: 11/511,033

(22) Filed: Aug. 28, 2006

(30) Foreign Application Priority Data
Apr. 6, 2006 (CN) 200620072211.7

(51) Int. Cl. B01D 50/00

(52) U.S. Cl. 55/337

(57) ABSTRACT

The present invention discloses a second-stage separator device for a vacuum cleaner, comprising a cylindrical barrel and a conical barrel that are vertically joined together, an exhaust tube coaxially disposed inside the cylindrical barrel, the side wall of the said cylindrical barrel being connected with two air inlets which have an involute central line and a rectangular longitudinal section, the two air inlets being disposed on the cylindrical barrel at the same height and staggered 180° in the circumference, with air inlets thereof being located in the common plane through the axis line of the cylindrical barrel and orientated oppositely. The present invention can increase the air inlet area of a dust cleaner and improve the dust-removal efficiency of a dust cleaner.

### TECHNICAL FIELD

The present invention relates to a second-stage separator device for a vacuum cleaner.

### BACKGROUND OF INVENTION

China Patent No.ZL02220336.2, which was issued on Mar. 5, 2003 by the SIPO of the People's Republic of China, discloses a deceleration centrifugal device for a dust cleaner. The centrifugal device comprises a cylindrical barrel with an exhaust tube and an inlet tube for air, a conical barrel and a dust collecting box, which are joined together from the top down in succession. The conical barrel is provided with a small upper end and a large bottom end. An umbrella shaped reflecting plate is provided inside the conical barrel below the exhaust tube, a circumfluence hole is disposed in the center of the umbrella shaped reflecting plate, and an annular gap for dust to drop through is formed between the circumferential edge of the umbrella shaped reflecting plate and the side wall of the conical barrel. The centrifugal device has characteristics of small loss in air pressure, good suction effect, high dust-filtering precision, low operation noise and the ability to avoid the secondary air pollution effectively, especially for the secondary filtering system and for separating fine dust.

However, due to the fact that there is only one air inlet in the above-mentioned separator device, it is difficult to enlarge the area of the air inlet. This situation is the primary cause that restrains the increase of the air volume of the dust cleaner.

### SUMMARY OF THE INVENTION

An object of the present invention is to provide a second-stage separator device for a vacuum cleaner which increases the air inlet area of the dust cleaner and improves the dust-removal efficiency of the dust cleaner.

According to one aspect of the present invention, there is provided a second-stage separator device for a vacuum cleaner, which includes a barrel, an exhaust tube and at least two air inlets each of which exhaust tube and air inlets are disposed on the barrel.

According to another aspect of the present invention, there is provided a second-stage separator which includes a barrel, an exhaust tube and at least two an air inlets each of which exhaust tube and air inlets are disposed on the barrel, wherein the barrel comprises a cylindrical barrel and a conical barrel that are vertically joined together, and wherein the exhaust tube is coaxially disposed inside the cylindrical barrel, and the air inlet is connected to the side wall of the cylindrical barrel.

According to a further aspect of the present invention, there is provided a second-stage separator device for a vacuum cleaner which includes a barrel, an exhaust tube and at least two air inlets each of which exhaust tube and air inlets are disposed on the barrel, wherein the barrel comprises a cylindrical barrel and a conical barrel that are vertically joined together, and wherein the exhaust tube in coaxially disposed inside the cylindrical barrel, and the air inlets are connected to the side wall of the cylindrical barrel so that the two air inlets are disposed on the cylindrical barrel at the same height and staggered 180° in the circumferential direction with the air inlets disposed in a common plane through the axis line of the cylindrical barrel and orientated oppositely so that the central lines of said two inlet tubes are involuted and the two inlet tubes have a rectangular longitudinal section.

Another object of the present invention is to provide a dust separating apparatus that increases the air inlet area of the dust cleaner and improves the dust-removal efficiency of the dust cleaner.

In accordance with the above objectives, the present invention provides a dust separating apparatus that includes a low efficiency cyclone with a tangential import having a prefilter for initially separating coarse contaminates and a high efficiency cyclone secondarily for separating fine contaminants which are not separated by the prefilter and arranged in said low efficiency cyclone. The dust separating apparatus includes a conduit having a plurality of air inlets and an air outlet. The air inlets are disposed in the prefilter and each is arranged in a tangential manner. A conical cylinder is connected with the conduit for producing a helical flow. A dust collector is attached to a lower end of the conical cylinder for collecting fine contaminants.

Preferably, the air inlets are located on a top end of the high efficiency cyclone.

Furthermore, each air inlet is preferably arranged in a different axial direction.

Additionally, the conduit is preferably manufactured integrally with the conical cylinder.

Still preferably, each air inlet is tangential to an axis of the air outlet.

Still another object of the present invention is to provide a vacuum cleaner that increases the air inlet area of the dust cleaner and improves the dust-removal efficiency of the dust cleaner.

In accordance with the above objectives, the present invention provides vacuum cleaner which includes a dirty air inlet for receiving a dust containing air stream, a clean air outlet spaced from the dirty air inlet, an air flow path extending downstream from the dirty air inlet to the clean air outlet and in flow communication with a source of suction, and a dust separating apparatus positioned in the air flow path. The dust separating apparatus includes a first cyclone and a second cyclone downstream from the first cyclone and a plurality of air inlets that are positioned in the air flow path downstream from the first cyclone and upstream of the second cyclone.

The advantages of the present invention are as follows:

1. As compared to prior art separator devices, the present invention adds an air inlet for increasing the air inlet area so that the air volume is increased and the dust-removal efficiency is improved.

2. The present invention uses two involuted air inlets. Accordingly, with the same inlet area, the width of the inlet can be reduced. As a result, the dust airflow is kept relatively far away from the central area when being sucked into dust-removal device. Under the same centrifugal force, the shorter the distance that the dust moves towards the wall, the more advantageous it is for the separating efficiency.

### BRIEF DESCRIPTION OF THE DRAWINGS

The present invention will be further described in the following in combination with the exemplary embodiments and with reference to the accompanying drawings.

FIG. 1 is a front view of a prior art device;

FIG. 2 is a top view of the cylindrical barrel in FIG. 1;

FIG. 3 is an exploded perspective view of the vacuum cleaner of the present invention;

FIG. 4 is a front view of the vacuum cleaner in FIG. 3;

FIG. 5 is a right view of the vacuum cleaner in FIG. 3;

FIG. 6 is a front view of the separator device of the present invention;

FIG. 7 is a top view of the cylindrical barrel of the separator in FIG. 6;

FIG. 8 is an assembly view of the dust-removal device provided with the separator device according to the present invention;

FIG. 9 is an overall view of the dust-removal device provided with the separator device according to the present invention.

### BEST MODE FOR CARRYING OUT THE INVENTION

A preferred embodiment of the present invention is described herein as being used with a vacuum cleaner and in particular with an upright vacuum cleaner. It will be appreciated that the improvements in multi-stage separation described herein may be used with canister vacuum cleaners, back pack vacuum cleaners, central vacuum cleaner systems as well as single and multi-stage separators of any sort, including industrial dust or particle collection systems wherein particles are to be removed from a fluid (i.e. a liquid and/or a gas).

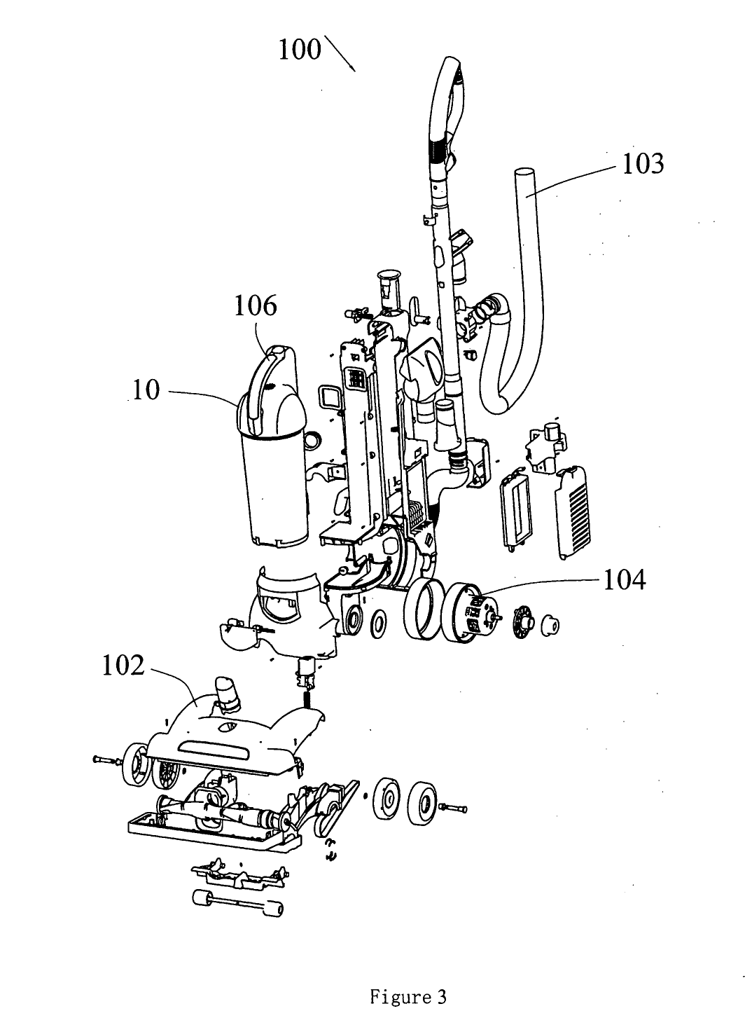

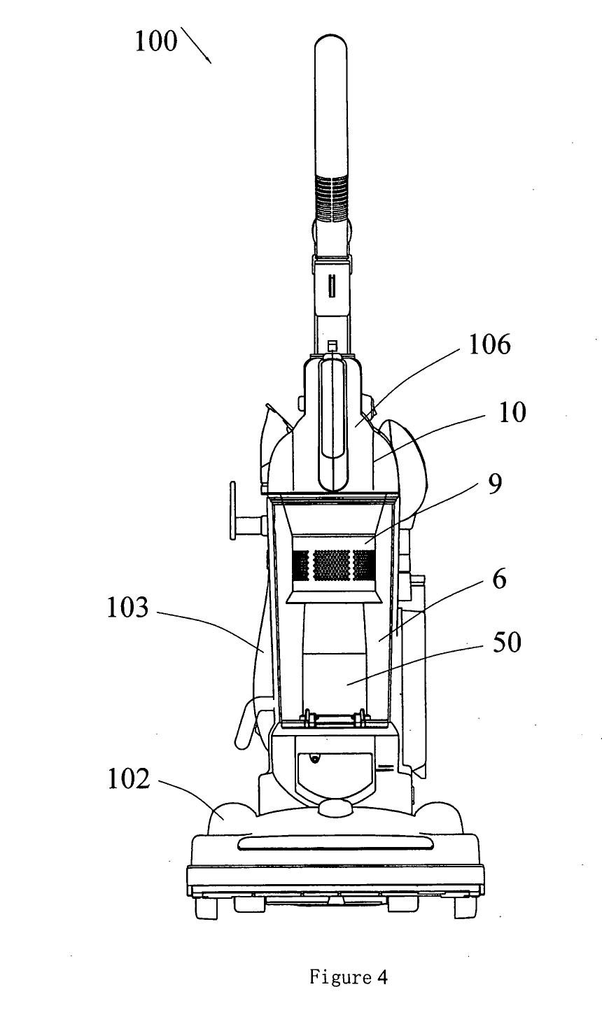

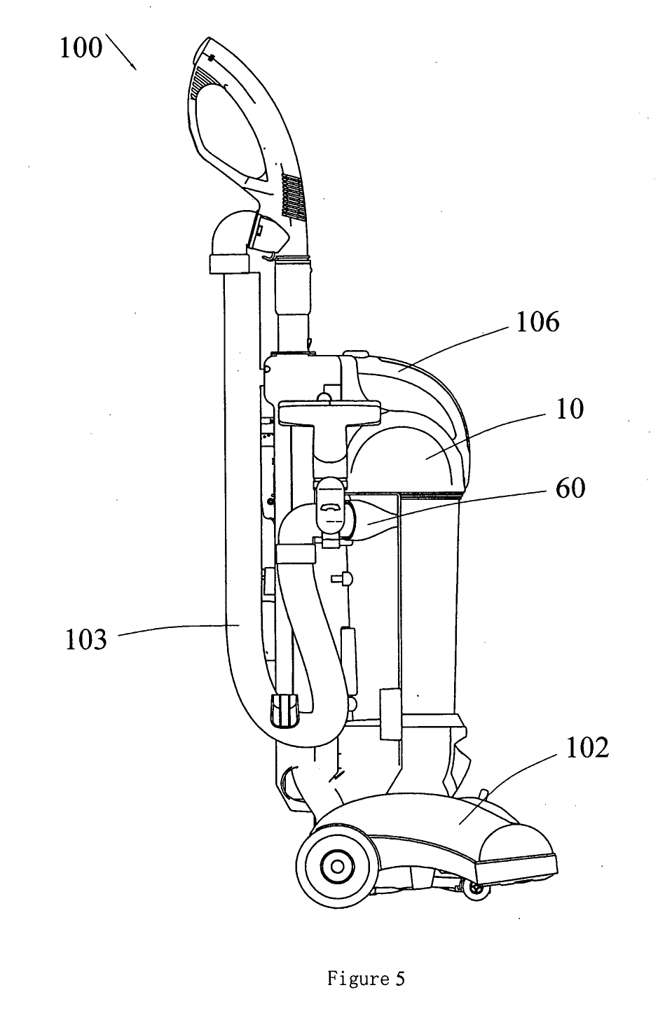

As shown in FIG. 3-5, the upright vacuum cleaner 100 comprises a nozzle 102 for introducing a dust containing air stream, a motor 104 for providing a suction source, a dust separating apparatus 106 for separating coarse and fine contaminants from the dust containing air stream, and a hose 103 connected with the nozzle 102 through the dust separating apparatus 106 for transferring the dust containing air stream. The dust separating apparatus 106 comprises a first cyclone or a first-stage separator 6, a second cyclone or a second-stage separator device 50 and an air flow path (not labeled) extending downstream from the dirty air inlet 60 to the clean air outlet 12 and in flow communication with the motor 104.

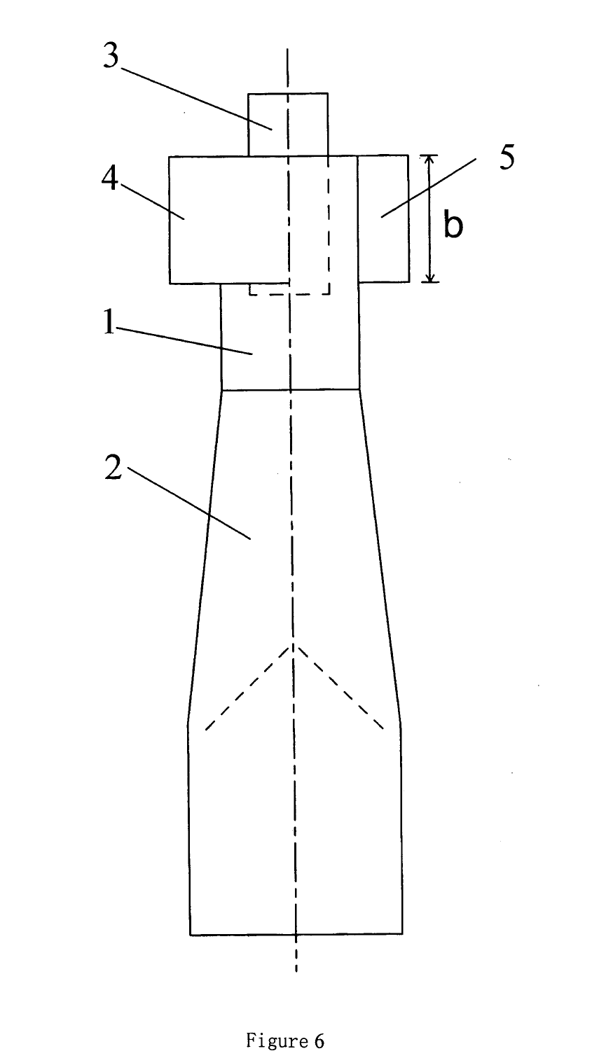

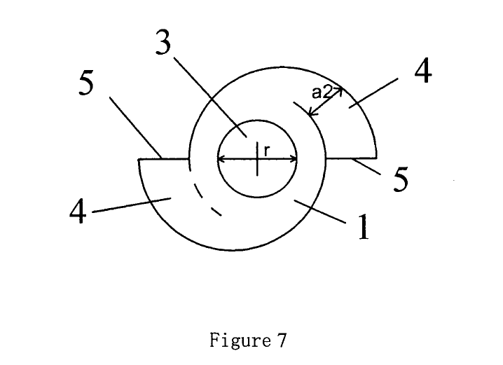

As shown in FIG. 6 and FIG. 7, a second-stage separator device 50 for the vacuum cleaner 100, comprises a cylindrical barrel 1 and a conical barrel 2 that are vertically joined together, an exhaust tube 3 coaxially disposed inside the cylindrical barrel 1, and two air inlets 4 that are connected to the side wall of the cylindrical barrel 1. Each of the two air inlets 4 has an involuted central line and a rectangular longitudinal section. The air inlets 4 are disposed on the cylindrical barrel 1 at the same height and staggered 180° in the circumferential direction, with air inlet openings 5 being coaxially disposed in the common plane through the axis line of the cylindrical barrel 1 and orientated opposed from one another.

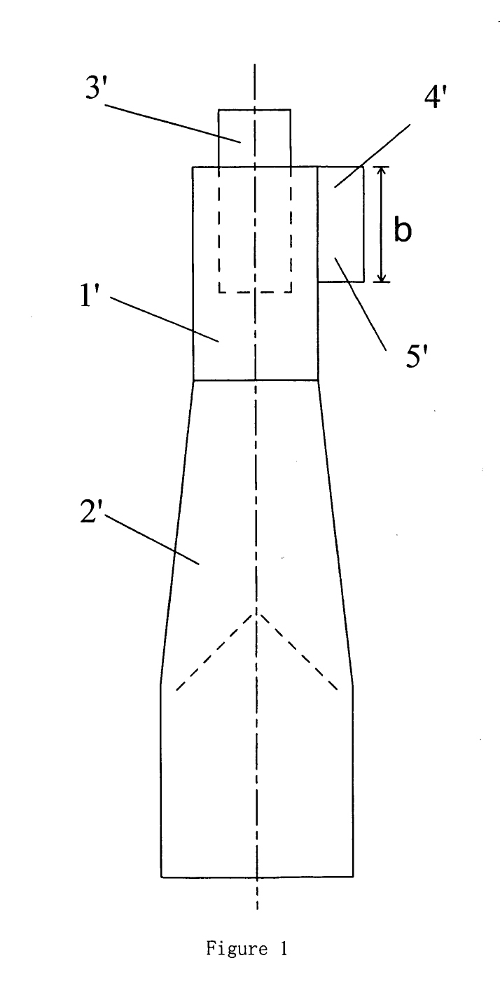

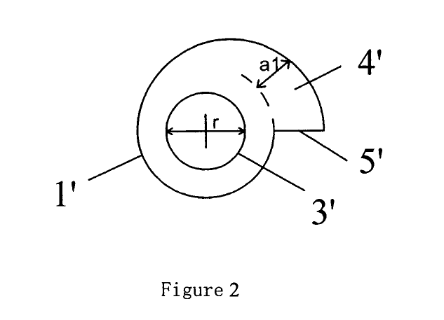

As shown in FIGS. 1 and 2, in the prior art device, the width of the air inlet 4′ is a₁ and the height thereof is b, so that the area m₁ is equal to a₁×b. The area m₁ becomes a bottleneck for the device and restricts the air volume, because the area m₁ is less than the area π r² of the exhaust tube 3′, which depends on the structure of the dust cleaner.

As shown in FIGS. 6 and 7, in order to increase the air inlet area, the present invention adopts a structure with two air inlets, and the air inlet area m2 is then equal to 2a₂×b, which is increased relative to that of the prior art device. At the same time, the outlet of the exhaust tube becomes the bottleneck for the device, if the area m₂ is greater than the area π r² of the exhaust tube. In order to address this situation and ensure the dust-removal efficiency, the air volume of the device can be increased by increasing the diameter of the exhaust tube 3.

In addition, with the same air inlet area and the same height of the air inlets, the width a₂ can be reduced, e.g. a₂ can be only half of a₁. Thus when the dust airflow is sucked into the body of the dust-removal device, it can keep far away from the center and accordingly contribute to improving the dust-removal efficiency.

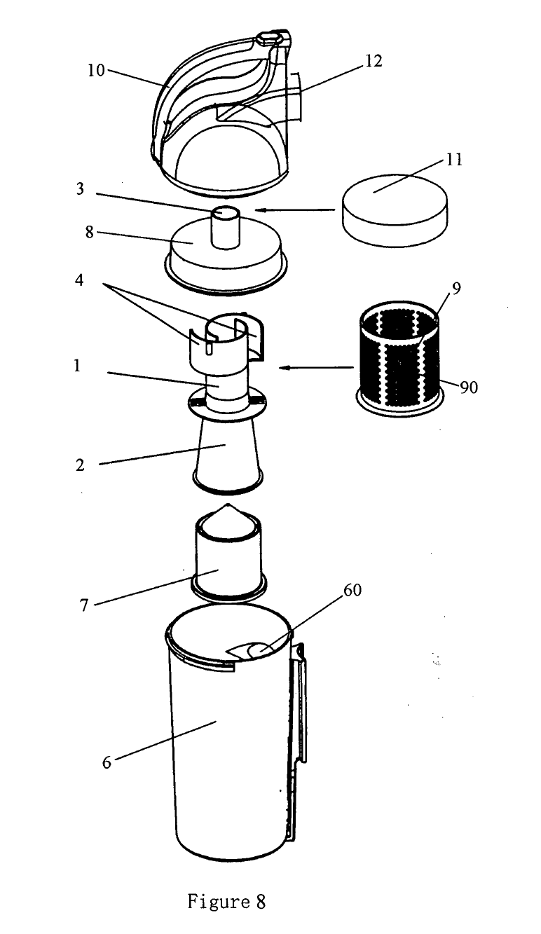

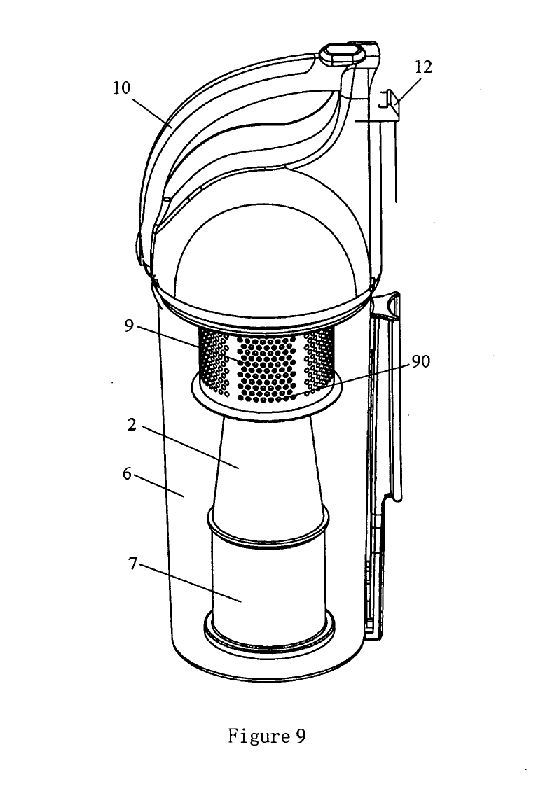

FIGS. 8 and 9 depict dust-removal devices that are provided with the separator device according to the present invention. These devices include a dust separating apparatus mounted with a second-stage separator device 50 with a pair of air inlets 4 according to the present invention. The devices further include a cylinder tank 6 with a cover lid 10, a cylindrical barrel 1 and a conical barrel 2 both of which are mounted within the cylinder tank 6. A dust collector 7 located below the conical barrel 2 is also provided within the cylinder tank 6. A cylinder filter cover 9, also referred to as a prefilter that has a plurality of pores 90 formed on the outer periphery thereof is coaxially arranged outside of the cylindrical barrel 1. The cylindrical barrel 1 and the cylinder filter cover or prefilter 9 are covered by a top cover 8 on which the exhaust tube 3 is provided. Additionally, a third filter 11, such as a piece of sponge, for further filtering the air is disposed on the top cover 8 for covering the exhaust tube 3 and for filtering the air flow before flowing out through the outlet 12 on one side of the cover lid 10.

In operation, a dust containing air stream may be introduced into the cylinder tank 6 by any means known in the art from a tangential inlet 60 thereon, and is filtered initially by the prefilter 9. Because the coarse contaminants can not enter into the pores 90 of prefilter 9, coarse contaminants drop downwardly while the air stream with the fine contaminants enters into the pores 90. The air stream with fine contaminants entrained therein enters into the cylindrical barrel 1 through the tangential air inlet 4 and is subjected to secondary filtration in the conical barrel 2 which has an upper end and a lower end wider than the upper end to separate fine contaminants not separated by the prefilter 9 as the air stream moves upwardly through exhaust tube 3. The filter 11 disposed on exhaust tube 3 will provide a third filtering stage for the air stream being about to be guided into the motor 104 of the vacuum cleaner 100 and lastly discharged into the atmosphere.

In this embodiment in which pair of air inlets 4 are provided in the dust separating apparatus 106, more air inlets can also be provided for further increasing the flow amount to meet variable requirements.

The present invention can be applied to various types of the vacuum cleaners, and particularly, to cyclonic vacuum cleaners so that convenience of use can be further improved.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A second-stage separator device for a vacuum cleaner that comprises:
a barrel;
an exhaust tube coupled to an end of the barrel; and
at least a pair of air inlets provided on the barrel.

2. The second-stage separator device for a vacuum cleaner as claimed in claim 1, wherein said barrel comprises a cylindrical barrel portion and a conical barrel portion that are vertically joined together and the exhaust tube is coaxially disposed inside the cylindrical barrel and each of the at least one pair of air inlets is connected to a side wall of the cylindrical barrel.

3. The second-stage separator device for a vacuum cleaner as claimed in claim 1, wherein each of said at least one pair of air inlets is disposed on the cylindrical barrel at a same height and staggered 180° in a circumferential direction with air inlet openings being disposed in a common plane through the axis line of the cylindrical barrel and orientated opposed to one another.

4. The second-stage separator device for a vacuum cleaner as claimed in claim 3, wherein each of said at least one pair of air inlets have involuted central lines.

5. The second-stage separator device for a vacuum cleaner as claimed in claim 3, wherein each of said at least one pair of air inlets have a longitudinal sections.

6. A dust separating apparatus for a vacuum cleaner which comprises:
a first cyclone with a tangential inlet and a prefilter for initially separating coarse contaminates from an air stream; and
a second cyclone for secondarily separating fine contaminants not separated by the prefilter, said second cyclone being arranged in said first cyclone (6) and comprising:
a conduit having a plurality of air inlets at an upper end thereof and an air outlet; said plurality of air inlets being disposed within said prefilter and each arranged in a tangential manner;
a conical cylinder connected with a lower end of said conduit for generating a helical flow thereof; and
a dust collector attached to a lower end of said conical cylinder for collecting fine contaminants.

7. The dust separating apparatus as claimed in claim 6, wherein said plurality of air inlets are located on a top end of said second cyclone.

8. A dust separating apparatus as claimed in claim 6, wherein each of said plurality of air inlets is aligned in a different axial direction.

9. The dust separating apparatus as claimed in claim 6, wherein said conduit is manufactured integrally with the conical cylinder.

10. The dust separating apparatus as claimed in claim 6, wherein each of said plurality of air inlets is tangential to an axis of said air outlet.

11. A vacuum cleaner which comprises:
a dirty air inlet for receiving a dust containing air stream;
a clean air outlet spaced for the dirty air inlet;
an air flow path extending downstream from the dirty air inlet to the clean air outlet and in flow communication with a source of suction; and
a dust separating apparatus positioned in the air flow path, the dust separating apparatus comprising:
a first cyclone and a second cyclone downstream from the first cyclone; and,
wherein a plurality of air inlets are positioned in the air flow path downstream from the first cyclone and upstream of the second cyclone.

12. The second-stage separator device for a vacuum cleaner as claimed in claim 2, wherein each of said at least one pair of air inlets is disposed on the cylindrical barrel at a same height and staggered 180° in a circumferential direction with air inlet openings being disposed in a common plane through the axis line of the cylindrical barrel and orientated opposed to one another.

13. The second-stage separator device for a vacuum cleaner as claimed in claim 12, wherein each of said at least one pair of air inlets have involuted central lines.

14. The second-stage separator device for a vacuum cleaner as claimed in claim 12, wherein each of said at least one pair of air inlets have longitudinal sections.
